(19) United States
(12) Patent Application Publication
(10) Pub. No.: US 2004/0012682 A1
(43) Pub. Date: Jan. 22, 2004

(54) Image capturing apparatus

(75) Inventors: Akira Kosaka, Yao-Shi (JP); Tsutomu Honda, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/612,127

(22) Filed: Jul. 2, 2003

(30) Foreign Application Priority Data
Jul. 8, 2002 (JP) P2002-198641

(51) Int. Cl. H04N 5/225

(52) U.S. Cl. 348/207.99

(57) ABSTRACT

A digital camera obtains a plurality of live view images in a time-series manner by using a CCD image capturing device and the like. A determination part of the digital camera determines whether a finger of the user is included in an objective area to be captured or not on the basis of the plurality of live view images. For example, the determination is made on the basis of a change with time in the position of a predetermined low-brightness area in the plurality of live view images. When both a shifted low-brightness area and a not-shifted low-brightness area exist, the not-shifted low-brightness area is regarded as a finger area. Alternately, the determination may be made on the basis of a change with time in contrast in a predetermined area in a plurality of images for AF obtained in a time-series manner while moving the position of a focusing lens. When the contrast value of the predetermined area continuously increases as the lens position approaches the near-side end, the predetermined area is regarded as a finger area.

This application is based on application No. 2002-198641 filed in Japan, the of which are hereby incorporated by reference.

### BACKGROUND OF THE INVENTION

1. Field of the Invention

The present invention relates to an image capturing apparatus such as a digital camera.

2. Description of the Background Art

In recent years, to address demands such as improvement in portability, the size of an image capturing apparatus such as a digital camera is being reduced. An example of the small-size image capturing apparatus is a digital camera of a size that fits in the palm of a hand. And, as a small-size image capturing apparatus, there is a digital camera of a type (flat type) having a shape that a lens unit does not project.

Such a small-size digital camera has a characteristic such that a phenomenon, so-called “unintentional finger image capture”, of unintentionally capturing an image of a finger of the user at the time of photographing due to the small size or shape easily occurs. Particularly, the “unintentional finger image capture” often occurs when the user takes a picture while performing framing with an optical finder for the following reason. Due to a mismatch between the optical axis of incident light to the optical finder and the optical axis of incident light to a CCD sensor, the field of view of an image framed with the optical finder and that of an image actually captured by the CCD sensor are different from each other. In the case where the user takes a picture while seeing an LCD (Liquid Crystal Display) on the rear face of the digital camera, such “unintentional finger image capture” can be prevented to some extent. However, when the user takes a picture in a hurry, the user may miss occurrence of unintentional finger image and capture an image.

Generally, a digital camera has a problem such that an image accompanying “unintentional finger image capture” as described above is captured. Particularly, as miniaturization of a digital camera progresses, this problem is becoming more conspicuous.

### SUMMARY OF THE INVENTION

An object of the present invention is to provide an image capturing apparatus capable of preventing an image accompanying “unintentional finger image capture” from being captured.

In order to achieve the object, according to a first aspect of the present invention, an image capturing apparatus includes: an image generator for capturing a subject and generating image data; a discriminator for discriminating whether a part of a user is included in an objective area to be captured or not on the basis of a plurality of pieces of image data generated in a time series manner by the image generator; and a controller for controlling operation of the image capturing apparatus on the basis of a result of discrimination of the discriminator.

With the image capturing apparatus, whether a part of the user is included in the area to be captured or not is determined on the basis of a plurality of images generated in a time-series manner, so that an image accompanying “unintentional finger image capture” can be prevented.

Further, the present invention is also directed to a method of controlling an image capturing apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing appearance of a digital camera according to the present invention;

FIG. 2 is a rear view of the digital camera;

FIG. 3 is a functional block diagram of the digital camera;

FIG. 4A is a diagram showing a time-series image where unintentional finger image capture does not occur, and FIG. 4B is a diagram showing a change in brightness in the x direction;

FIG. 5A is a diagram showing another time-series image where unintentional finger image capture does not occur, and FIG. 5B is a diagram showing a change in brightness in the x direction;

FIG. 6A is a diagram showing a time-series image where unintentional finger image capture occurs, and FIG. 6B is a diagram showing a change in brightness in the x direction;

FIG. 7A is a diagram showing another time-series image where unintentional finger image capture occurs, and FIG. 7B is a diagram showing a change in brightness in the x direction;

FIG. 8 is a diagram showing a peripheral portion at the left end and a peripheral portion at the right end;

FIG. 9 is a flowchart showing operation of detecting unintentional finger image capture according to a first embodiment;

FIG. 10 is a flowchart showing operation of detecting unintentional finger image capture according to the first embodiment;

FIG. 11 is a diagram for describing deletion of an unintentional finger image capture area;

FIG. 12 is a diagram showing a plurality of focus evaluation areas;

FIG. 13 is a diagram showing a detailed configuration of a contrast computing part in an AF controller;

FIG. 14 is a diagram showing an image in a state where focus is not achieved on a main subject in the center;

FIG. 15 is a diagram showing an image in a state where focus is achieved on a main subject in the center;

FIG. 16 is a diagram showing a change curve of a contrast value in a focus evaluation area in the center;

FIG. 17 is a diagram showing a change curve of the contrast value in a focus evaluation area in a peripheral portion;

FIG. 18 is a diagram showing an image in a state where focus is not achieved on a main subject in the center (the case where unintentional finger image capture occurs);

FIG. 19 is a diagram showing an image in a state where focus is achieved on a main subject in the center (the case where unintentional finger image capture occurs);

FIG. 20 is a diagram showing an image when the lens position reaches the near side end (in the case where unintentional finger image capture occurs);

FIG. 21 is a diagram showing a change curve of the contrast value in the focus evaluation area in the center;

FIG. 22 is a diagram showing a change curve of the contrast value in the focus evaluation area in the peripheral portion (the case where unintentional finger image capture occurs);

FIG. 23 is a flowchart showing operation of detecting unintentional finger image capture according to a second embodiment;

FIG. 24 is a flowchart showing operation of detecting unintentional finger image capture according to a third embodiment;

FIG. 25 is a flowchart showing operation of detecting unintentional finger image capture according to the third embodiment;

FIG. 26 is a flowchart showing operation of detecting unintentional finger image capture according to a fourth embodiment.

### DESCRIPTION OF THE PREFERRED EMBODIMENTS

Hereinafter, embodiments of the present invention will be described with reference to the drawings.

A. First Embodiment

A1. Configuration

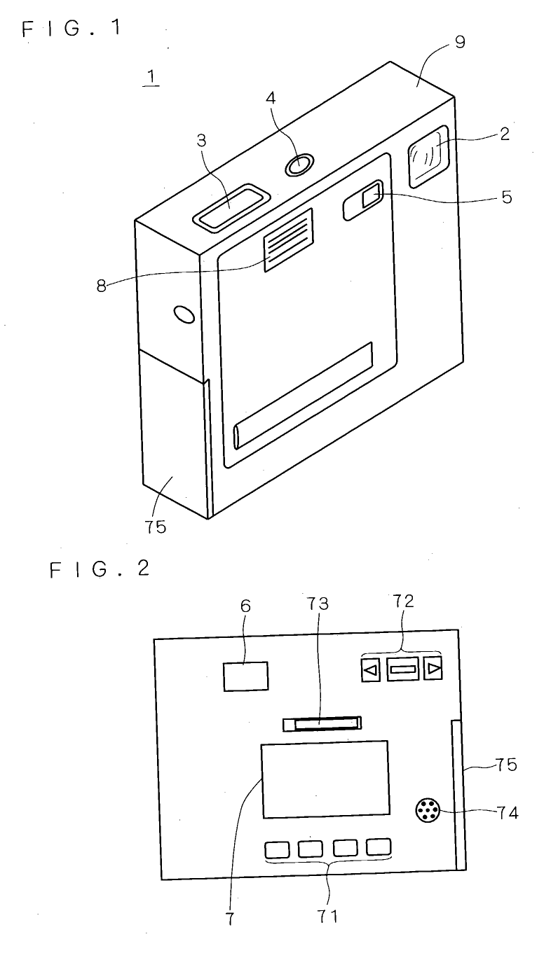

FIG. 1 is a perspective view showing appearance of a digital camera (image capturing apparatus) 1 according to the present invention. FIG. 2 is a rear view of the digital camera 1.

As shown in FIGS. 1 and 2, the digital camera 1 includes a lens 2, a shutter release button 3, a power button 4, a finder objective window 5, a finder eyepiece window 6, an LCD 7, a flash 8, various buttons 71 and 72, a slide switch 73, and a speaker 74.

The lens 2 is a lens having a focus function and a zoom function. A moving mechanism for realizing the zoom function is provided in a camera body 9. Consequently, also at the time of using the zoom function, the lens 2 is not projected from the camera body 9.

The shutter release button 3 is provided on the top face of the digital camera 1. The shutter release button 3 is a two-stage press switch capable of detecting a lightly pressed state (S1) and a fully pressed state (S2) by the user. As will be described later, in the lightly pressed state S1, operation of determining presence or absence of unintentional finger image capture is started. In the fully pressed state S2, image capturing operation (photographing operation) for capturing an image-to-be-recorded is started.

The finder objective window 5 is provided on the front face side (subject side of the digital camera 1, and the finder eyepiece window 6 is provided on the rear face side (user side) of the digital camera 1. The user can see an optical image of the subject obtained through the finder objective window 5 by peeping through the finder eyepiece window 6 on the rear face side.

The LCD 7 is provided on the rear face side of the digital camera 1. By using the LCD 7, display of a live view image for preview before photographing (also referred to as “live view display” or “preview display”), display of an after-view image for recognizing an image immediately after photographing (referred to as after-view display), reproduction and display of an image recorded on a memory card 59 (recording medium), and the like are performed.

The various buttons 71 and 72 and the slide switch 73 function as operation parts used for various menu operations and the like. Further, the speaker 74 functions as an output part for outputting various sound information.

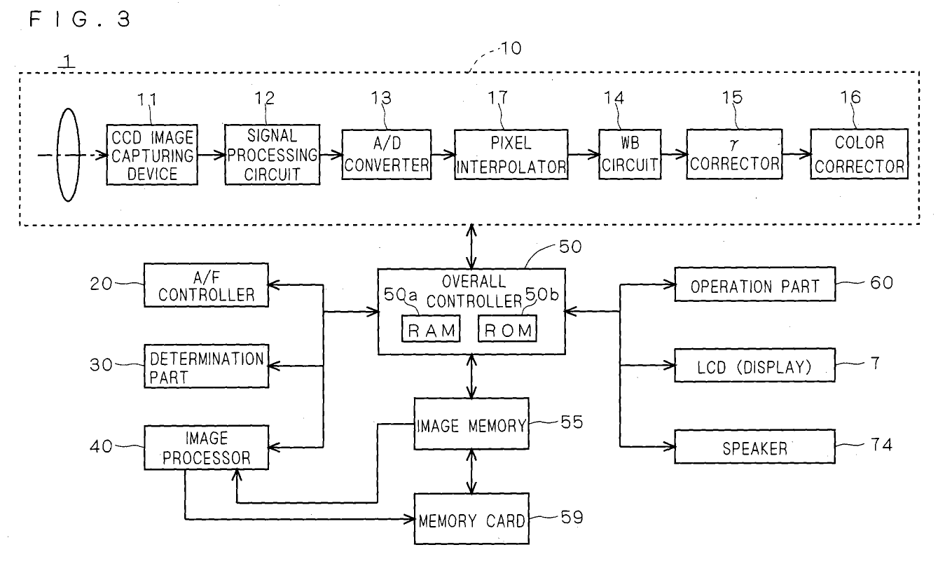

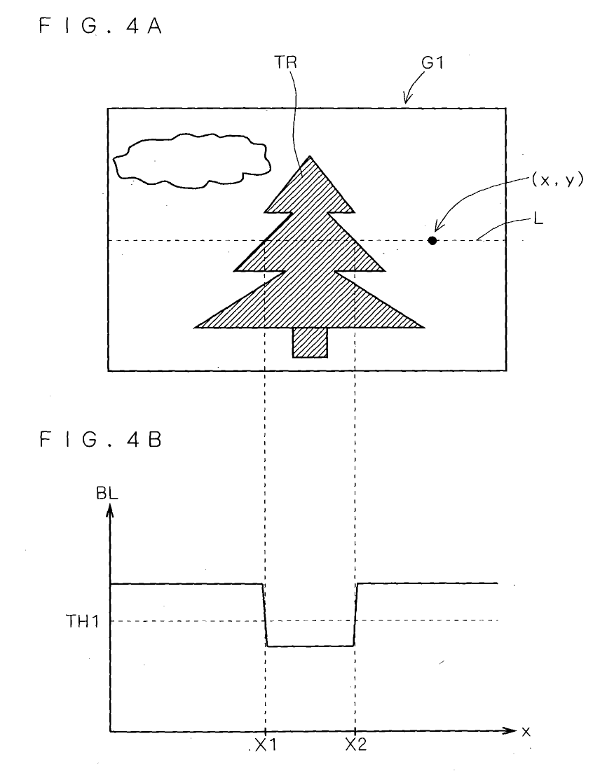

FIG. 3 is a functional block diagram of the digital camera 1.

As shown in FIG. 3, the digital camera 1 has an image capturing function part 10, an auto-focus (hereinafter, also referred to as AF) controller 20, a determination part (or discrimination part) 30, an image processor (an image controller) 40, an overall controller 50, an image memory 55, the memory card 59, an operation part 60, and the like.

The image capturing function part 10 has a taking lens 2, a CCD image capturing device 11, a signal processing circuit 12, an A/D converter 13, an image interpolator 17, a WB (White Balance) circuit 14, a y corrector 15, and a color corrector 16.

The CCD image capturing device 11 photoelectrically converts an optical image of the subject into an electric signal (image signal).

The signal processing circuit 12 performs a predetermined analog signal process on an image signal (analog signal) obtained from the CCD image capturing device 11. The signal processing circuit 12 has a correlated double sampling (CDS) circuit and an auto gain control (AGC) circuit. By the correlated double sampling circuit, a process of reducing noise in an image signal is performed. By adjusting the gain with the auto gain control circuit, level adjustment of the image signal is carried out.

The A/D converter 13 converts an analog image signal to a digital signal having a predetermined number of tones. The pixel interpolator 17 interpolates signals of R, G, and B in a checker pattern obtained by the CCD image capturing device 11. The WB (White Balance) circuit 14 performs level shift of each of the color components of R, G, and B. The γ corrector 15 is a circuit for correcting the tone of pixel data. The color corrector 16 performs color correction on the basis of a parameter regarding color correction which is set by the user on image data inputted from the γ corrector 15, and converts color information expressed in the RGB color space to color information expressed in the YCrCb color space. By the color system conversion, brightness component values Y are obtained with respect to all of pixels.

The image memory 55 is a memory for temporarily storing image data obtained by the CCD image capturing device 11 and subjected to the above-mentioned image process. The image memory 55 has a storage capacity of at least one frame. When a recording instruction is given by the user, image data is transferred from the image memory 55 to the memory card 59 and is recorded and stored.

The memory card 59 is a portable recording medium and has a storage capacity sufficient to record a plurality of captured (photographed) images. The memory card 59 can be inserted/ejected to/from a card slot provided on the inside of a cover 75 (see FIG. 1) in a state where the cover 75 provided on a side portion of the digital camera 1 is open. Although the case where the captured image is recorded on a removable portable recording medium will be described here, the present invention is not limited to such a case but the captured image may be recorded on the recording medium fixed on the inside of the digital camera 1.

The operation part 60 is an operation part including the buttons 71 and 72 and the slide switch 73 and is a member used by the user to make settings of the digital camera 1.

Further, the AF controller 20 performs an evaluation value calculating operation for carrying out auto-focus control of a hill-climbing method (contrast method), control of driving the lens 2, and the like.

The determination part 30 has the function of determining (discriminating) whether or not a finger of the user is included in an objective area to be captured (photographed), which is set by a framing operation (hereinafter, also referred to as “area-to-be-photographed” or “framed area”) on the basis of a plurality of images of a subject obtained in a time-series manner. That is, the determination part 30 has the function of determining occurrence of “unintentional finger image capture (finger obstruction)”. The operation of the determination part 30 will be described in detail later.

The image processor 40 has the function of, when it is determined that a finger of the user is included in the area-to-be-photographed, generating an image-to-be-recorded from which the area including a finger of the user is deleted and recording the generated image into the memory card 59.

The overall controller 50 is constructed by a microcomputer having therein a RAM 50a and a ROM 50b and functions as controller for controlling the components in a centralized manner when the microcomputer executes a predetermined program.

The above-described components are provided in the small-size camera body 9. The digital camera 1 has a small size that fits in the palm of a hand and is constructed very compactly.

The user performs framing to determine the composition of a subject while supporting the camera body 9 with his/her hand or hands. The user may perform framing while peeping the finder eyepiece window 6 or while seeing the LCD 7. In any case, due to the circumstances such as the small size of the digital camera 1 and the type of the camera in which the lens 2 is not projected also at the time of photographing (flat type), there is the possibility that a finger of the user enters the area-to-be-photographed, that is, “unintentional finger image capture” may occur.

A2. Principle

With reference to FIGS. 4A and 4B to FIG. 8, the principle of detecting “unintentional finger image capture” in the embodiment will be described.

In the embodiment, by detecting existence of a portion which does not change with a camerashake or a change in framing while referring to a plurality of live view images, “unintentional finger image capture” is detected.

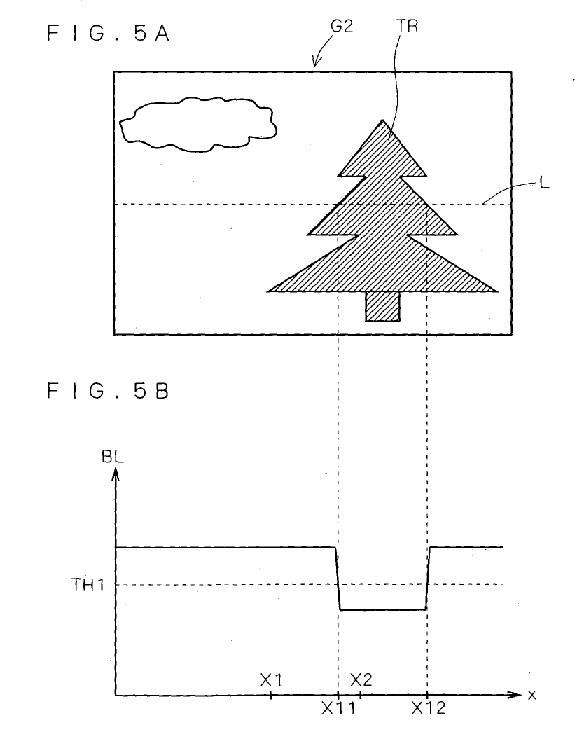

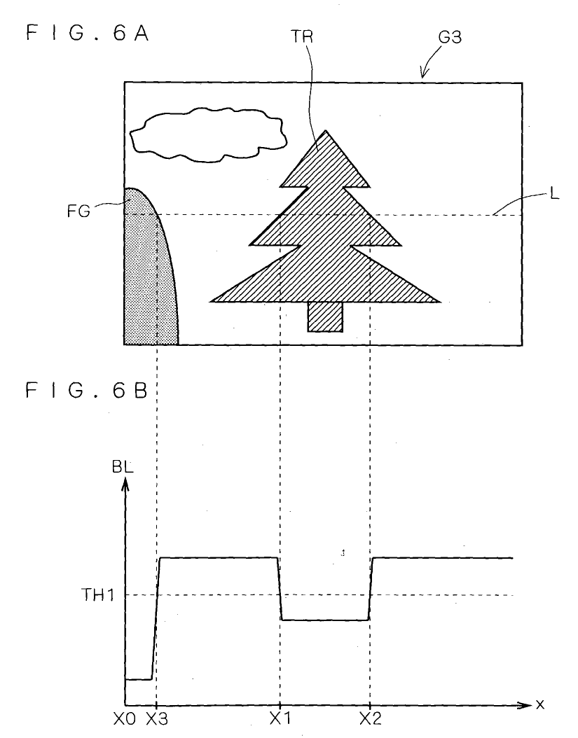

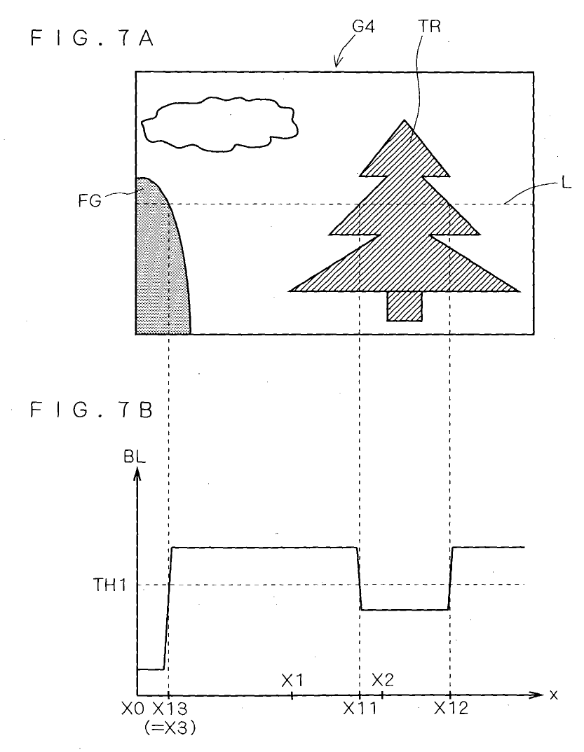

FIGS. 4A and 5A are diagrams showing two images G1 and G2, respectively, in a plurality of time-series images in the case where unintentional finger image capture does not occur. FIG. 4A shows the image G1 at predetermined time T1 and FIG. 5A shows the image G2 at predetermined time T2 (>T1) which is after time T1. FIGS. 6A and 7A are diagrams showing two images G3 and G4, respectively, in a plurality of time-series images in the case where unintentional finger image capture occurs. FIG. 6A shows the image G3 at predetermined time T1 and FIG. 7A shows the image G4 at predetermined time T2 (>T1) which is after time T1. Each of FIGS. 6A and 7A shows a state where an image of a finger FG of the user is captured in a left part of the screen.

FIG. 4B is a diagram showing a change curve in the x direction of brightness BL of a pixel (x, y) having a predetermined y coordinate in the image G1. In other words, FIG. 4B is a diagram showing a change curve of brightness in a horizontal line L in the image G1. In FIG. 4B, the horizontal axis denotes an x coordinate of each pixel, and the vertical axis denotes the brightness BL of each pixel. Similarly, FIG. 5B is a diagram showing a change curve of the brightness BL of a pixel (x, y) having the same y coordinate in the image G2.

As shown in FIG. 4B, the brightness of a tree TR as a main subject is low as compared with a subject in the periphery. A zone between X1 and X2 corresponding to the tree in the image G1 is also referred to as an area in which the pixel value of each pixel is lower than a predetermined threshold TH 1 (hereinafter, also referred to as “low brightness area”). Similarly, as shown in FIG. 5B, a zone between X11 and X12 corresponding to the tree TR in the image G2 is a low brightness area.

As understood by comparison between FIGS. 4A and 4B and FIGS. 5A and 5B, in the image G2, the position of the tree TR as a main subject is deviated from the position of the tree TR in the image GI due to a camerashake or a change in framing. In this case, the zone between X11 and X12 corresponding to the tree TR in the image G2 is shifted to the right with respect to the zone between X1 and X2 corresponding to the tree in the image G1. In other words, the relations X11>X1 and X12>X2 are set. Since the width of the tree TR does not change, the width of the low brightness area also is not changed by the shift. That is, the relation of X2−X1=X12−X11 is satisfied.

The images G3 and G4 in the case where unintentional finger image capture occurs will now be described.

FIGS. 6B and 7B will be referred to. Like FIG. 4B, FIG. 6B is a diagram showing a change curve of the brightness BL of a pixel (x, y) having a predetermined y coordinate in the image G3 at time T1 before a shift. Like FIG. 5B, FIG. 7B is a diagram showing a change curve of the brightness BL of the pixel (x, y) having the same y coordinate in the image G4 at time T2 after the shift.

As shown in FIGS. 6B and 7B, in the images G3 and G4, the low brightness area corresponding to the tree TR exits in a manner similar to FIGS. 4B and 5B. In the image G4 shown in FIG. 7A, the position of the tree TR as a main subject and the like is shifted from that in the image G3 due to a camerashake or a change in framing. A state is shown here in which the zone between X11 and X12 corresponding to the tree in the image G4 is shifted to the right as compared with the zone between X1 and X2 corresponding to the tree in the image G3. Specifically, the relations X11>X1 and X12>X2 are satisfied. Since the width of the tree does not change, the width of the low brightness area also is not changed by the shift. That is, the relation of X2−X1=X12−X11 is satisfied.

In the images G3 and G4, in addition to the low brightness area corresponding to the tree, the low brightness area corresponding to the finger FG of the user also exists.

Since brightness of the image area corresponding to the finger FG of the user is lower than that of the subject in the periphery, the zone between X0 and X3 and the zone between X0 and X13 corresponding to the finger FG of the user are low brightness areas.

The x coordinate X3 at the right end of the finger area (hereinafter, which denotes an area corresponding to the finger FG in the image) in the image G3 before the shift has the same value as the x coordinate X13 at the right end of the finger area in the image G4 after the shift for the following reason. The position in the image of the finger existing at the left end of the image is not changed by a camerashake or a change in framing.

Therefore, when the conditions are satisfied such that the area of which position changes due to a shift (herein, the low brightness area) exists whereas the low brightness area of which position is unchanged exists, it can be determined that unintentional finger image capture occurs. Although the low brightness area is used as an area of which position changes, the present invention is not limited to the area. For example, whether an area of which position changes due to a shift exists or not may be determined by using a high brightness area.

Although the brightness value of each of pixels in one horizontal line L is used here, the present invention is not limited to the case but, for example, brightness values of pixels in a plurality of lines may be used. Alternately, the brightness value of each of pixels in a predetermined area may be used.

Further, whether a low brightness area of which position does not shift exits or not may be considered only in the peripheral portions other than the center portion of an image for the reason that unintentional finger image capture usually occurs in the peripheral portion BP in a screen.

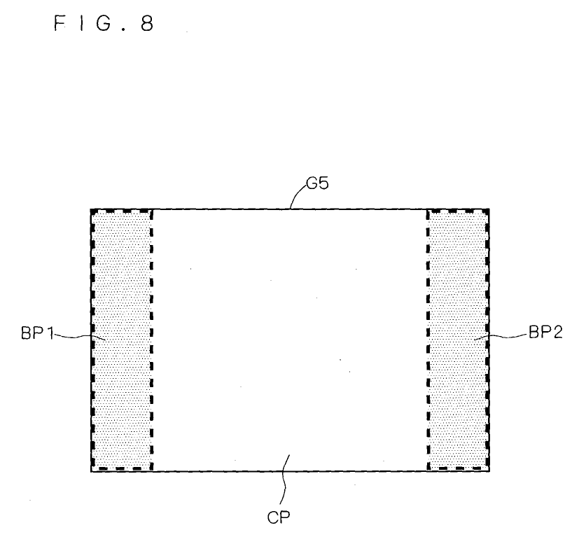

For example, under a condition that a low brightness area of which position does not change has an overlapped portion with the peripheral portion BP1 at the left end or the peripheral portion BP2 at the right end of the image G5 as shown in FIG. 8, the low brightness area may be determined as a finger area. Consequently, when a low brightness area of which position does not change exists only in the center portion CP, it is determined that the low brightness area is not the finger area. Thus, erroneous determination can be reduced and the occurrence of unintentional finger image capture can be determined more accurately.

Although “unintentional finger image capture” is determined here under condition that the x coordinate values X3 and X13 at the right end of the low brightness areas in the two images G3 and G4 captured at different times are the same, the values may not be completely the same but may be almost the same. For example, by using as a condition that the absolute value of the difference between the X coordinate values X3 and X13 is equal to or lower than a predetermined threshold, unintentional finger image capture may be determined.

A3. Operation

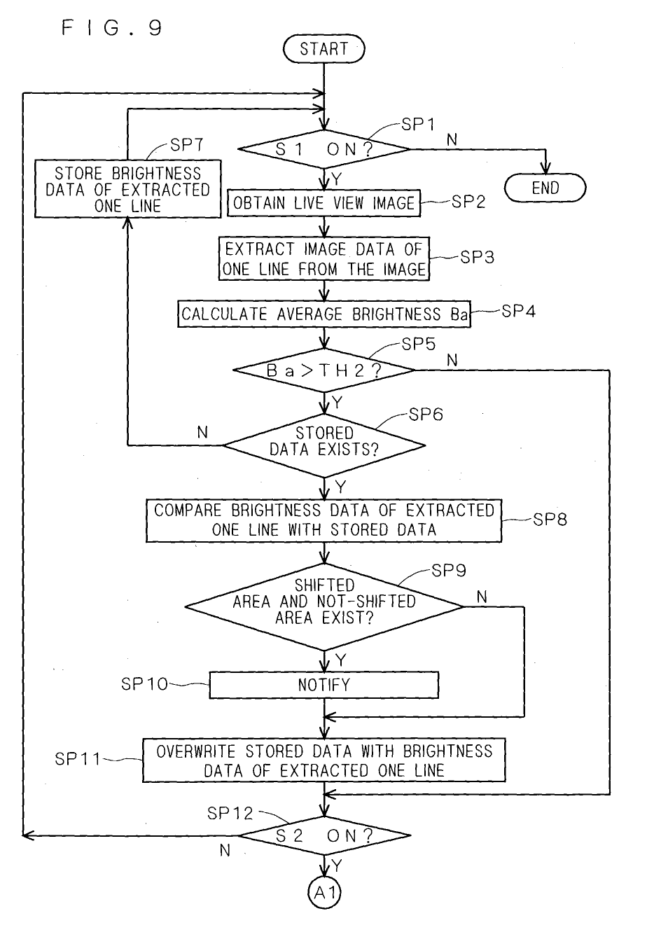

With reference to FIGS. 9 and 10, an operation of detecting the unintentional finger image capture and the like will be more specifically described. In the following, it is assumed that the user determines an area-to-be-photographed while seeing a plurality of preview images displayed on the LCD 7 (that is, the state of performing framing). FIGS. 9 and 10 are flowcharts showing the flow of the operation. It is assumed herein that the operation is a subroutine process referred to from a main routine at predetermined intervals.

First, only when the user lightly presses the shutter release button 3 (state S1) in step SP1, the program advances to step SP2. When the shutter release button 3 is not in the lightly pressed state S1, the process is finished. Since the subroutine process is repeatedly called and executed every predetermined time, whether the shutter release button 3 is lightly pressed (state S1) or not is checked in predetermined cycles. At the time when the shutter release button 3 is lightly depressed (state S1), the program advances to the next step SP2.

In step SP2, a live view image (or an image for AF) is obtained. The determination part 30 extracts image data of one horizontal line L from the captured live view image (or image for AF) and generates brightness data on the basis of the extracted image data (step SP3). The brightness data is calculated on the basis of a pixel value of a pixel in each position (x, y).

The determination part 30 calculates average brightness Ba on the basis of the generated brightness data (step SP4) and, after that, compares the average brightness Ba with a predetermined threshold TH2 (step SP5). When the average brightness Ba is larger than the threshold TH2, the program advances to the next step SP6. If NO (in the case where the average brightness Ba is equal to or less than the threshold TH2), the program advances to step SP12 without performing processes in steps SP6 to SP11. In such a manner, by not performing the unintentional finger image capture determining process on an image whose general brightness is low such as an image captured in the dark, erroneous determination regarding unintentional finger image capture can be avoided.

In step SP6, the determination part 30 determines whether data stored on the memory (also referred to as stored data) already exists or not. If YES, the program advances to step SP8. If NO, the program advances to step SP7. In step SP7, brightness data of one horizontal line L extracted in step SP3 is stored as the stored data on the image memory 55. After that, the program returns to step SP1. The stored data is stored without being subjected to a compressing process.

In step SP8, the determination part 30 compares the brightness data of one horizontal line L extracted in step SP3 with the stored data and performs a branching process in step SP9 in accordance with a result of the comparison.

As described above, when both the shifted low-brightness area and a not-shifted low-brightness area exist, the determination part 30 determines that unintentional finger image capture occurs. When the determination part 30 determines that unintentional finger image capture does not occur, the program advances to step SP11. If the determination part 30 determines that unintentional finger image capture occurs, the program advances to step SP10 where a notifying operation is performed. Examples of the notifying operation are, concretely, indication of a note by characters of “Note: finger is in” on the display 7 or a predetermined figure and output of sound of a note from a speaker or voice.

After that, in step SP11, the stored data is overwritten with the brightness data of the one horizontal line L extracted. By overwriting the stored data, the image memory 55 can be effectively utilized. Particularly, the stored data is stored in a state where it is not subjected to the compressing process, so that the memory capacity saved by overwriting becomes a relatively large value.

In step SP12, whether the shutter release button 3 is in the fully depressed state S2 or not is determined. The processes in steps SP1 to SP11 are repeated until the shutter release button 3 enters the fully depressed state S2. When the shutter release button 3 enters the fully depressed state S2, the program advances to step SP13 (FIG.10).

In steps SP13 and SP14, an image exposed at the latest timing is read from the CCD and temporarily stored as a captured image into the image memory. In step SP13, the image signal according to exposure at the latest timing is read from the CCD and subjected to a predetermined imaging process, thereby generating image data. After that, in step SP14, the image data is stored as a captured image into the built-in image memory 55.

In the next step SP15 and subsequent steps, in the case where an image accompanying the unintentional finger image capture irrespective of the notification is captured, a process of deleting a finger image portion from the image to be recorded or the like is performed. The procedure will be described later.

First, in step SP15, a branching process is performed according to a result of the comparison in steps SP8 and SP9. When it is determined that “unintentional finger image capture” does not occur, the program advances to step SP17 without performing a process in step SP16. On the other hand, when it is determined that unintentional finger image capture occurs, the program advances to step SP16 where a finger image area is deleted and, after that, advances to step SP17.

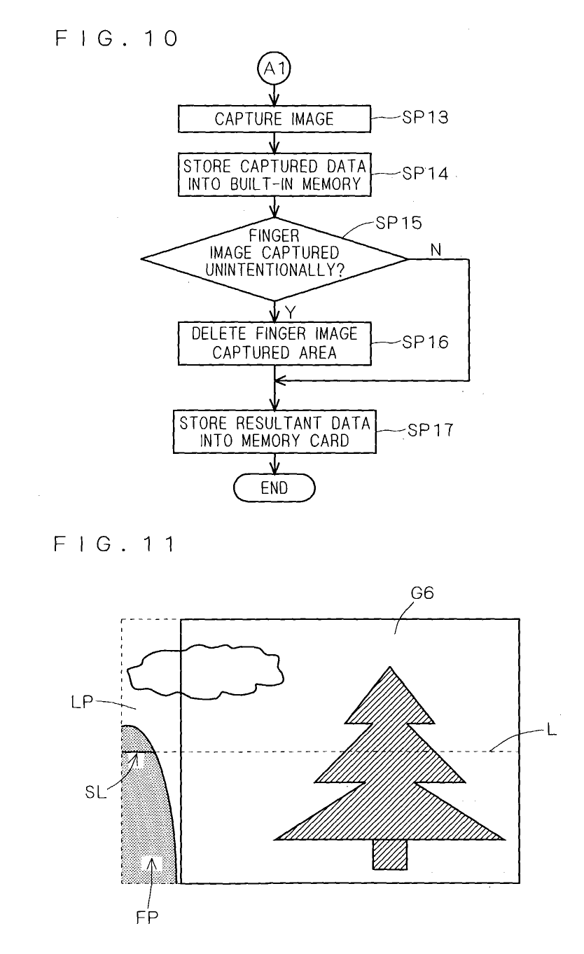

FIG. 11 is a diagram for describing deletion of the unintentional finger image capture area after detection of the unintentional finger image.

In step SP16, the finger area is detected and extracted from the image captured in steps SP13 and SP14, and an image G6 (FIG. 11) obtained by deleting an area LP including the finger area FP from the original captured image is generated. More concretely, it is sufficient for the image processor 40 to extract, as the finger area FP, by using a low brightness area as a segment area SL in one horizontal line as a reference, a low brightness area extending two-dimensionally from the segment area SL. By deleting a rectangular area LP including the finger area FP from the original image, the image G6 is generated.

In step SP17, the generated image G6 is stored as an image for recording on the memory card 59. When unintentional finger image capture does not occur, the original image captured in steps SP13 and SP14 is stored as an image for recording.

As described above, on the basis of a plurality of images (live view images or images for AF) of a subject obtained in a time-series manner, whether a finger of the user is included in the area-to-be-photographed or not is determined. More specifically, based on a change with time of the position of a predetermined low brightness area in each image, whether a finger of the user is included in the area-to-be-photographed or not is determined. Therefore, an image accompanying “unintentional finger image capture” can be prevented from being captured.

Since the user is notified of occurrence of unintentional finger image capture by the notifying operation, the user can easily recognize a situation in which “unintentional finger image capture” occurs. Therefore, capturing of an image accompanying “unintentional finger image capture” can be more reliably prevented. Further, by generating an image for recording obtained by deleting the area including a finger of the user and recording the generated image onto the predetermined memory card 59 (recording medium), an image accompanying “unintentional finger image capture” can be prevented from being recorded as an image for recording (captured image) on a predetermined recording medium. Since the finger area is preliminarily deleted at the time point of recording of the captured image, it is unnecessary to delete the finger area by performing an image editing process by using a digital camera, an external personal computer, or the like on a captured image. In short, the effort of such image editing process can be omitted.

Further, to detect “unintentional finger image capture” more reliably, it is also possible to determine whether the low brightness area is the finger area or not by also using hue information of the low brightness area. More concretely, in the determination process in step SP9, in addition to the above-described conditions, when the condition that the ratio of the number of pixels of flesh color to all of pixels in the low brightness area which does not shift exceeds a predetermined value is also satisfied, the determination part 30 may determine that the low brightness area is the finger area. Whether each pixel is a pixel of flesh color or not may be determined according to whether or not components (Cr, Cb) indicative of hue or the like of each pixel exist in an area corresponding to flesh color (flesh color corresponding area) in a Cr—Cb plane in a color space expression (Y, Cr, Cb) after the color system conversion of each pixel. The operation of detecting the number of pixels of flesh color in the low brightness area may be performed by the determination part 30 or the like in step SP9 or at a predetermined time point before step SP9.

B. Second Embodiment

B1. Principle

A second embodiment is a modification of the first embodiment. In the following, a point different from the first embodiment will be mainly described.

In the second embodiment, the case of determining whether a finger of the used is included in an image or not by using a plurality of images which are obtained in a time-series manner while shifting the position of the lens 2 (more accurately, a focusing lens in the lens 2), more specifically, the case of determining whether a finger of the user is included in an image or not on the basis of a change with time of contrast in a predetermined area will be described.

FIG. 12 is a diagram showing a plurality of focus evaluation areas FR0 to FR8(FRi; i=0, . . . , 8). Each focus evaluation area FRi is provided in an image G10 taken by the CCD image capturing device 11. In the second embodiment, the contrast value C in each focus evaluation area FRi is computed as an evaluation value for AF and is used also for determining unintentional finger image capture.

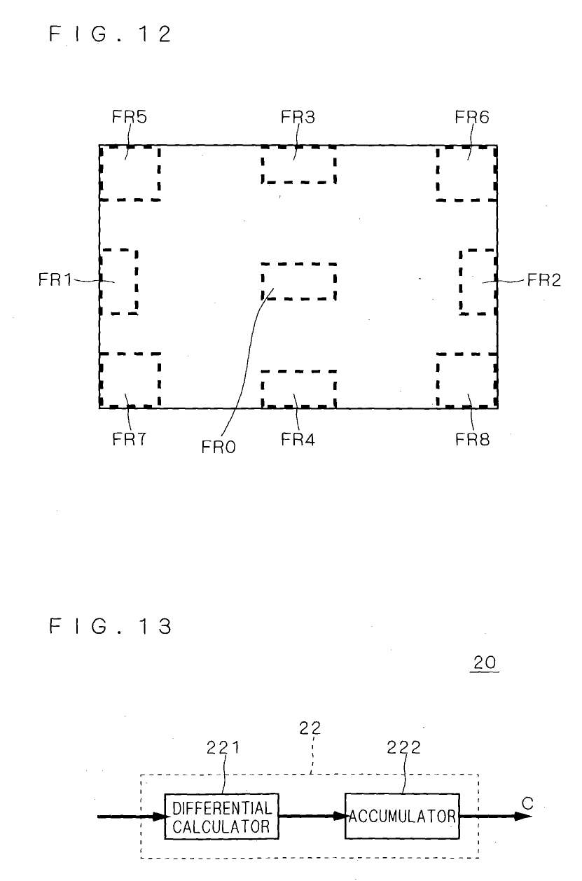

FIG. 13 is a diagram showing the detailed configuration of a contrast computing part 22 of the AF controller 20.

The contrast computing part 22 includes: a differential calculator 221 for obtaining a differential absolute value between a target pixel and a pixel adjacent to the target pixel and having a predetermined positional relation with the target pixel; and an accumulator 222 for accumulating results of the differential computation. The differential calculator 221 performs computation until all of pixels included in the focus evaluation area FRi are selected as target pixels. The accumulator 222 sequentially accumulates a differential absolute value obtained when each pixel included in the focus evaluation area FRi is selected as a target pixel and finally obtains the contrast value C of the focus evaluation area FRi.

When the contrast computing part 22 computes the contrast value C, the computation may be performed on the basis of pixel data of each of the color components of R, G, and B. It is also possible to generate brightness data from the pixel data of each of the color components of R, G, and B and perform the computation on the basis of the brightness data.

An operation of determining whether “unintentional finger image capture” occurs or not by using, to simplify explanation, the focus evaluation area FR0 in the center and the focus evaluation area FR1 in the peripheral portion among the plurality of focus evaluation areas will be described.

First, the state where “unintentional finger image capture” does not occur will be considered.

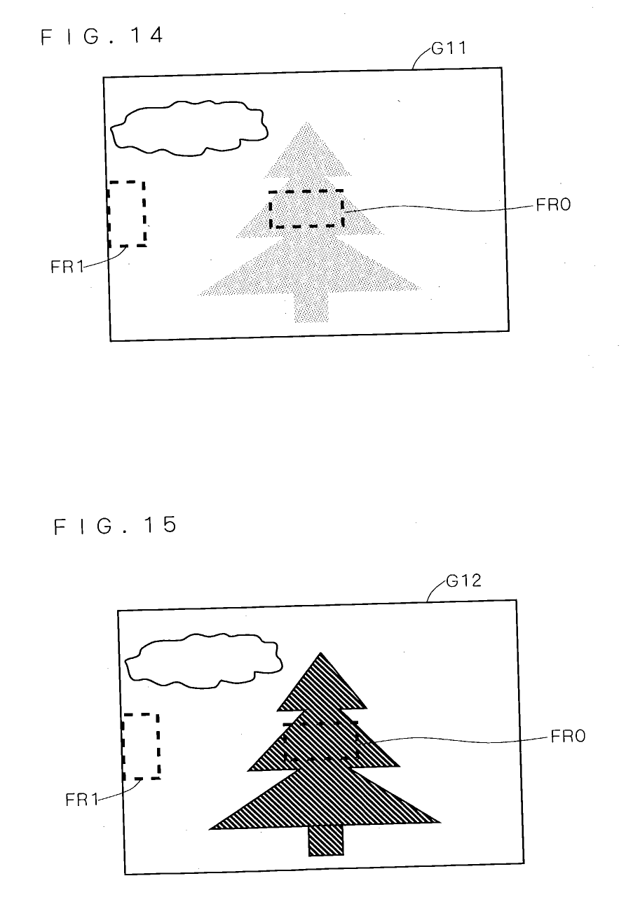

FIG. 14 is a diagram showing an image G11 in a state where focus is not achieved on a main subject in the center, which is a so-called “out-of-focus” state. FIG. 15 is a diagram showing an image G12 in a state where focus is achieved on a main subject in the center, which is a so-called focused state.

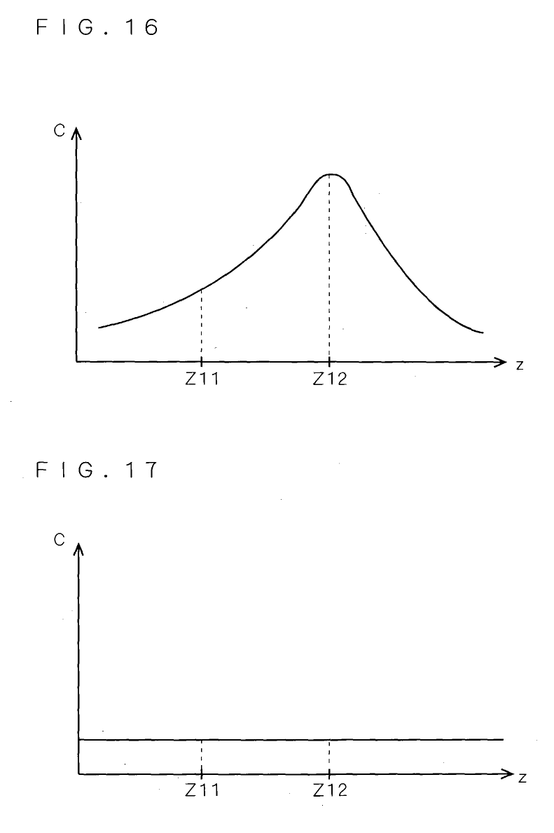

FIG. 16 is a diagram showing a change curve of the contrast value C in the focus evaluation area FR0 in the center in a plurality of images. The horizontal axis indicates the position of the lens 2 (more accurately, a focusing lens in the lens 2) in the optical axis direction. The vertical axis expresses the contrast value C of an image corresponding to each lens position.

As shown in FIG. 16, in the focus evaluation area FR0, the contrast value of the image G12 obtained in a lens position z12 is larger than the contrast value of the image G11 obtained in a lens position z11. Since a subject including many edge components exists in the focus evaluation area FR0, the contrast value changes according to the lens position. In this example, the contrast value has a peak value in the lens position z12 (focus position).

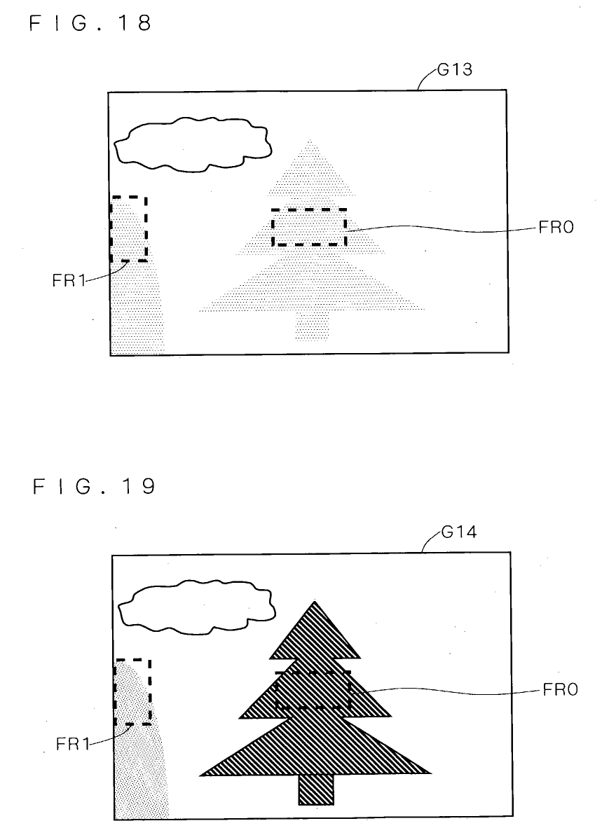

FIG. 17 is a diagram showing a change curve of the contrast value C of the focus evaluation area FR1 in the peripheral portion in a plurality of images. Since a subject including many edge components does not exist in the focus evaluation area FR1, the contrast value of the image G12 is almost the same as the contrast value of other images obtained in different lens positions. That is, the contrast value in the focus evaluation area FR1 in the peripheral portion hardly changes even when the lens position of the focusing lens is changed.

A state where “unintentional finger image capture” exists will now be examined.

FIGS. 18 to 20 are diagrams showing images G13, G14, and G15 each showing a state where “unintentional finger image capture” occurs. The lens position at the time of obtaining an image changes from the far side to the near side in order from the images G13, G14, and G15.

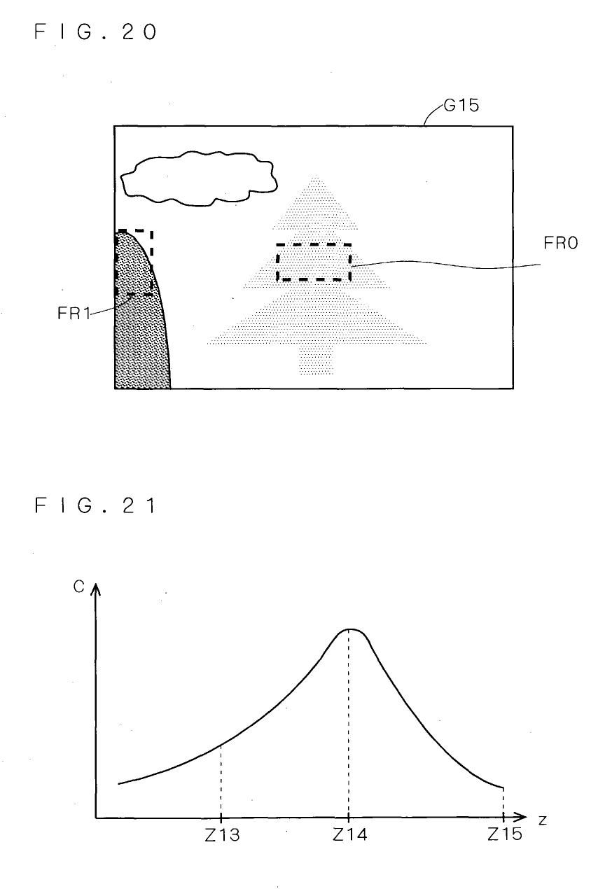

FIG. 18 is a diagram showing the image G13 in a state where focus is not achieved on a main subject in the center, which is a so-called “out-of-focus” state. FIG. 19 is a diagram showing the image G14 in which focus is achieved on a main subject in the center, which is a so-called focus state. FIG. 20 is a diagram showing the image G15 in a state where focus is not achieved on the main subject in the center since the lens is moved to the near side too much, which is again the out-of-focus state.

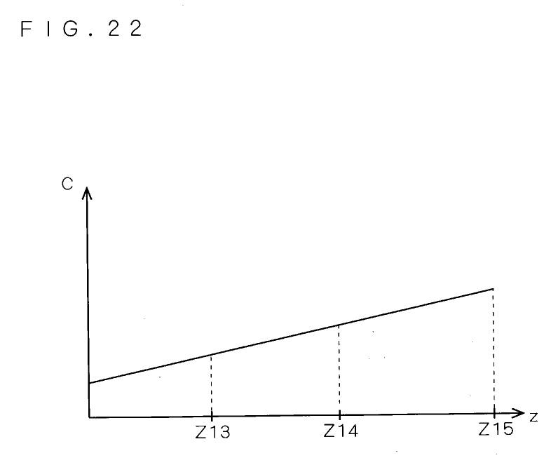

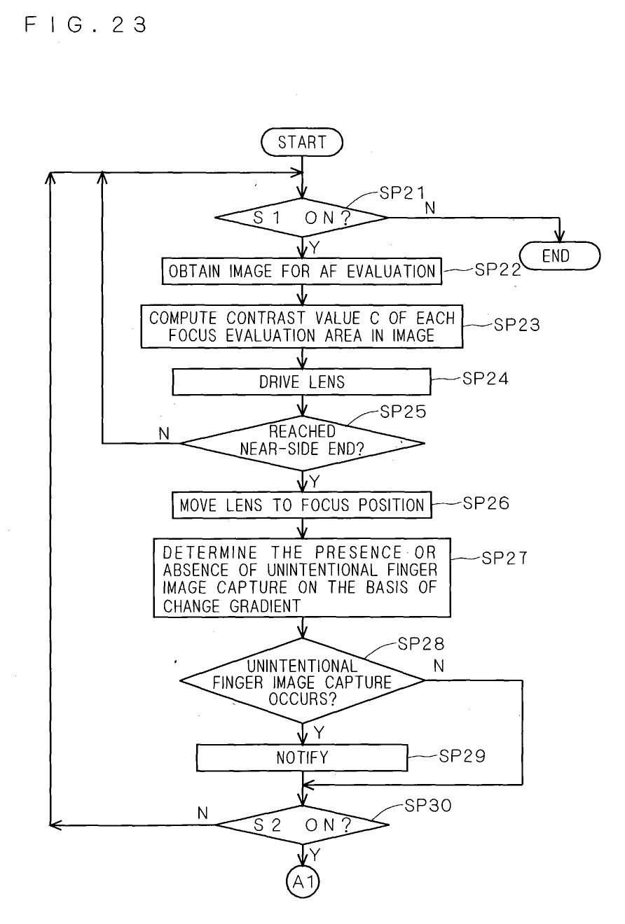

FIG. 21 is a diagram showing a change curve of the contrast value C in the focus evaluation area FR0 in the center portion. FIG. 22 is a diagram showing a change curve of the contrast value C in the focus evaluation area FR1 in the peripheral portion.

As shown in FIG. 21, the contrast value C in the focus evaluation area FR0 becomes the maximum value when the lens position z is a position z14 at the time of obtaining the image G14. Since a subject including many edge components exists in the focus evaluation area FR0, the contrast value changes according to the lens position and has a peak value in the lens position z14 (focus position).

On the other hand, as shown in FIG. 22, as the lens position z changes from the far side to the near side (more concretely, as the position z changes like the positions z13, z14, and z15), the contrast value C in the focus evaluation area FR1 increases. The contrast value C becomes the maximum value in the lens position z15 at which the image G15 is obtained, but a peak value as a maximum value does not exist. It means that the subject in the focus evaluation area FR1 exists in a position closer than the in-focus subject position corresponding to the lens position z15. That is, a finger of the user exists in a position extremely close to the lens 2.

As described above, in each of the focus evaluation areas FR1 to FR8 (for example, FR1) in the peripheral portion, when the contrast value C continuously increases as the lens position changes from the far side to the near side and the peak value as the maximum value does not exist, it can be determined that “unintentional finger image capture” occurs. On the other hand, in each of the focus evaluation areas FR1 to FR8 (for example, FR1) in the peripheral portion, when the peak value of the contrast value C exists as the lens position changes from the far side to the near side, it can be determined that “unintentional finger image capture” does not occur.

It is unnecessary to move the focusing lens through the entire lens driving range. For example, when the focusing lens is moved from a predetermined lens position in the lens drive range only to the near side and the contrast value C continuously increases with shift of the lens position to the near side, it can be determined that “unintentional finger image capture” occurs. On the other hand, when the contrast value C does not continuously increase as the lens position shifts to the near side (concretely, when the contrast value C continuously decreases, when the contrast value C is continuously almost the same value, or when the peak value of the contrast value C is detected), it can be determined that “unintentional finger image capture” does not occur.

B2. Operation

FIG. 23 is a diagram showing the operation of the second embodiment. In step SP30 and thereafter, the same operations as those in steps SP13 to SP17 shown in FIG. 10 are performed.

In the following, the case of performing auto-focus operation of obtaining the focus position by using the focus evaluation area FR0 out of the plurality of focus evaluation areas and determining whether “unintentional finger image capture” occurs or not by using the focus evaluation areas FR1 to FR8 in the peripheral portion will be described.

It is assumed that the user performs an operation of determining an area-to-be-photographed while seeing a plurality of preview images displayed on the LCD 7 (that is, framing operation). When the shutter release button 3 is lightly pressed (state S1), the auto-focus control starts. When the shutter release button 3 is fully pressed (state S2), the image capturing (photographing) operation for capturing an image for recording is started.

First, only when the shutter button 3 is set in the lightly pressed state S1 by the user in step SP21, the program advances to the next step SP22 where the auto-focus control operation starts. On the other hand, when the shutter release button 3 is not in the lightly pressed state S1, the process is finished. Since the subroutine process is repeatedly called every predetermined time and executed, whether the shutter release button 3 is set in the lightly pressed state S1 or not is checked at predetermined intervals. At the time point when the shutter release button 3 is set in the lightly pressed state S1, the program advances to step SP22.

In step SP22, an image for AF evaluation is obtained. Only immediately after the shutter release button 3 enters the lightly pressed state S1, the lens is moved to the far side end as the initial position and then the operation of obtaining an image for AF evaluation is performed in order to scan the whole lens driving range by driving the lens to the near side little by little.

After that, the auto-focus controller 20 computes the contrast value C of each focus evaluation area FRi in an obtained image (step SP23) and drives the focusing lens to the near side only by a predetermined small amount (step SP24). Until it is determined in step SP25 that the lens position reaches the near side end, the operations in steps SP21, SP22, SP23, and SP24 are repeated. By the above, a change curve of the contrast in each focus evaluation area FRi can be obtained.

In step SP26, based on the gradient of a change in the contrast value of the focus evaluation area FR0 in the center, the lens position in which focus is achieved on a subject (focus position) is calculated. Concretely, the auto-focus controller 20 calculates, as a focus position, the lens position (for example, position z14 (FIG. 21)) corresponding to the peak value in the charge curve of the contrast value. The lens 2 is moved to the focus position.

In step SP27, the determination part 30 determines whether “unintentional finger image capture” occurs or not in each of the focus evaluation areas FR1 to FR8 in the peripheral portion. The determination part 30 performs the determining operation based on the above-described principle with respect to each of the focus evaluation areas FR1 to FR8.

In the branching process of the next step SP28, when occurrence of “unintentional finger image capture” is determined with respect to any of the focus evaluation areas FR1 to FR8, the program advances to step SP29 where notification of occurrence of “unintentional finger image capture” is sent. On the other hand, when it is determined that “unintentional finger image capture” does not occur in any of the focus evaluation areas FR1 to FR8, the notification is not sent and the program advances to step SP30.

In step SP30, whether the shutter release button 3 is set in the fully pressed state S2 or not is determined. Until the shutter release button 3 enters the fully pressed state S2, the processes in steps SP21 to step SP29 are repeated. When the shutter release button 3 enters the fully pressed state S2, the program advances to step SP13 (FIG. 10). Since the subsequent processes are similar to those in the first embodiment, the description will not be repeated.

As described above, according to the second embodiment, on the basis of changes with time in contrast in predetermined areas (focus evaluation areas FR1 to FR8) in a plurality of images obtained in a time-series manner while shifting the position of the focusing lens, whether a finger of the user enters the area-to-be-photographed or not is determined. Thus, an image accompanying “unintentional finger image capture” can be prevented from being captured.

To detect “unintentional finger image capture” more reliably, it is also possible to determine whether each of the focus evaluation areas FR1 to FR8 is the finger area or not also by using hue information of the focus evaluation areas FR1 to FR8. More concretely, it is sufficient for the determination part 30 to determine that each of the focus evaluation areas FR1 to FR8 is the finger area in the determining process in step SP27 when a condition that the ratio of the number of pixels of flesh color to the number of all of pixels in each of the focus evaluation areas FR1 to FR8 exceeds a predetermined value is satisfied in addition to the above-described conditions.

In the second embodiment, the case where the focus position is obtained by using the focus evaluation area FR0 in the center among the plurality of focus evaluation areas and whether “unintentional finger image capture” occurs or not is determined by using the focus evaluation areas FR1 to FR8 is the peripheral portion has been described. However, the present invention is not limited to the case.

For example, whether “unintentional finger image capture” occurs or not may be determined by also using the focus evaluation area FR0 in the center portion. Alternately, occurrence of “unintentional finger image capture” may be determined by using only the focus evaluation areas (for example, FR1, FR5, and FR7) as part of the focus evaluation areas FR1 to FR8 is the peripheral portion. At the time of obtaining the focus position, not only the focus evaluation area FR0 in the center but also the other focus evaluation areas FR1 to FR8 is the used.

C. Third Embodiment

A third embodiment is a modification of the first embodiment. The third embodiment is different from the first embodiment with respect to operation performed after it is determined that “unintentional finger image capture” occurs in a framed image (image indicative of an area-to-be-photographed) in a live view display. In the third embodiment, a technique of performing “release lock” as an operation after the determination will be described as an example. In the following, points different from the first embodiment will be mainly described.

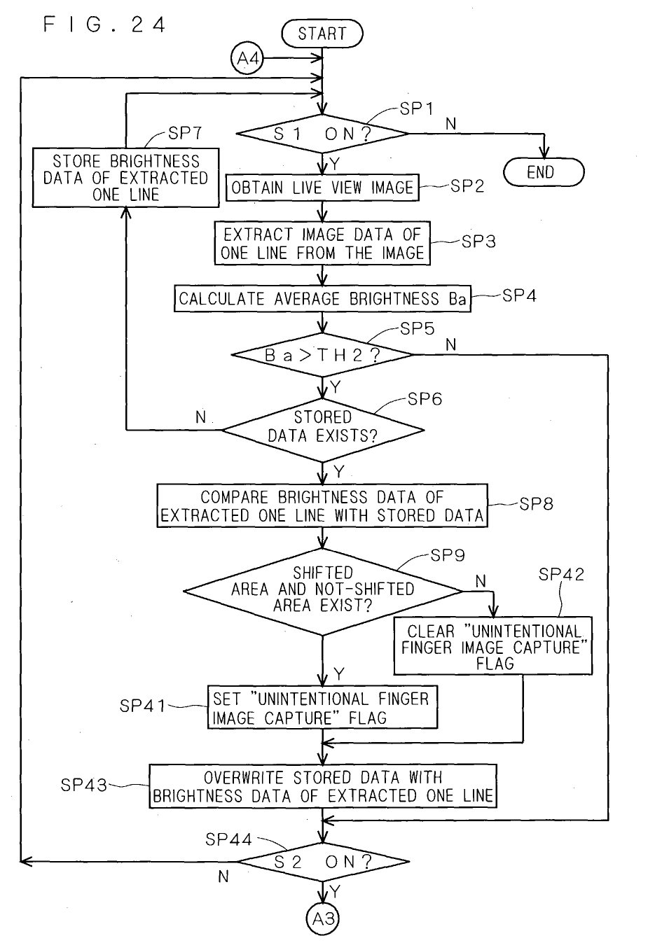

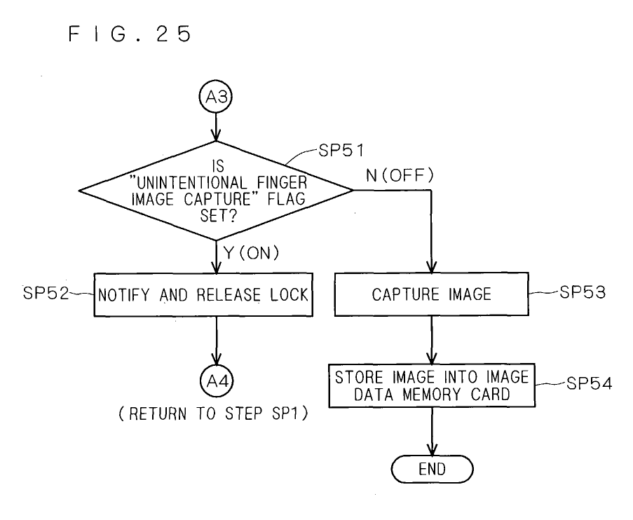

FIGS. 24 and 25 are flowcharts showing an operation of detecting “unintentional finger image capture”, an operation after the detecting operation, and the like in the third embodiment.

In FIG. 24, operations in steps SP1 to SP9 are similar to those in the first embodiment. After that, in step SP9, when existence of both of a not-shifted low-brightness area and a shifted low-brightness area is detected, the determination part 30 regards the state as a state in which “unintentional finger image capture” occurs, and sets a finger capture flag (step SP41). On the other hand, when existence of both of the areas is not detected, the determination part 30 determines that the state is not the “unintentional finger image capture” state and clears the finger capture flag (step SP42). The “finger capture flag” is stored in a predetermined storage area such as the RAM 50a provided in the overall controller 50.

The operation in step SP43 is the same as that in step SP11. Stored data is overwritten with brightness data in one horizontal line L extracted in step SP3.

In step SP44, whether the shutter release button 3 is fully pressed (state S2) or not is determined. If the shutter release button 3 is not in the fully pressed state S2, the process in steps SP1 to SP9 and SP41 to SP43 are repeated. When the shutter release button 3 enters the fully pressed state S2, the program advances to step SP51 (FIG. 25).

In step SP51, the determination part 30 checks whether the finger capture flag is set or not. If the flag is set, the program advances to step SP52. If the flag is not set, the program advances to step SP53.

In step SP53, the latest image is taken in response to depression of the shutter release button 3. Concretely, an image signal according to exposure of the latest timing is read from the CCD and subjected to a predetermined imaging process, thereby generating image data. After that, the image data is stored as a captured (photographed) image into the memory card 59 (step SP54), and the image capturing operation is finished.

On the other hand, in step SP52, notification similar to that in step SP10 is generated and the shutter release button 3 is locked so as not to be pressed. That is, release lock is performed. By the release lock, capture of an image accompanying “unintentional finger image capture” can be prevented more reliably.

The “release lock” may be carried out by using a mechanical mechanism or by software for preventing the image capturing operation from starting even when the shutter release button is fully pressed (state S2). The release lock is made under control of the overall controller 50.

D. Fourth Embodiment

A fourth embodiment is a modification of the first and third embodiments. The fourth embodiment is different from the first and third embodiments with respect to an operation performed after it is determined that “unintentional finger image capture” occurs in a framed image in a live view display. In the fourth embodiment, a technique of adjusting time of displaying an after-view to facilitate erasing of an image accompanying “unintentional finger image capture” as an operation after the determination will be described as an example. In the following, points different from the third embodiment will be mainly described.

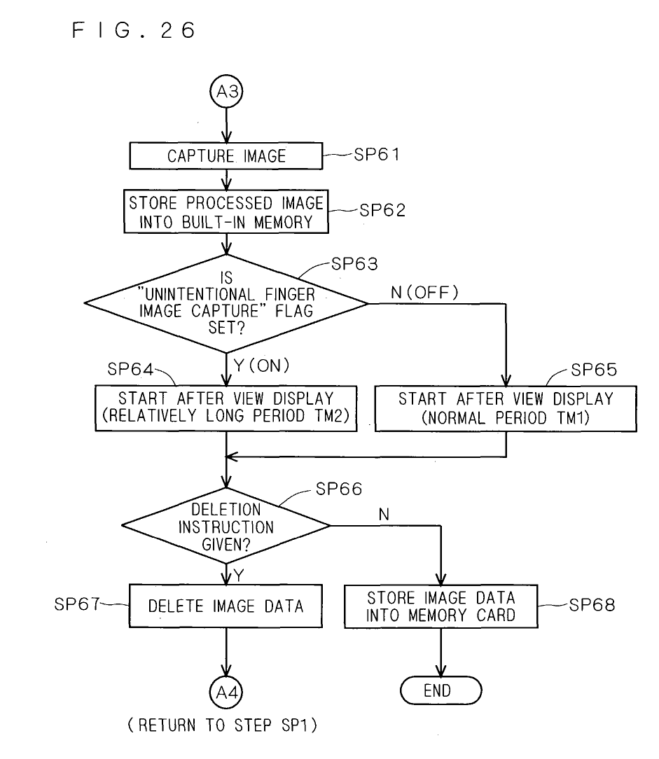

FIG. 26 is a diagram showing operations in the fourth embodiment. The operations before step SP61 are the same as those in steps SP1 to SP9 and SP41 to SP44 shown in FIG. 24, so that they are not shown.

As shown in FIG. 26, after the shutter release button 3 is fully depressed (state S2), the program advances to step SP61.

In step SP61, in response to depression of the shutter release button 3, an operation of capturing the latest image is performed. Concretely, an image signal according to exposure of the latest timing is read from the CCD and subjected to a predetermined imaging process, thereby generating image data. After that, the image data is stored as a captured image into the built-in image memory 55 (step SP62).

In step SP63, the determination part 30 checks whether the finger capture flag is set or not. If the flag is set, the program advances to step SP64. If the flag is not set, the program advances to step SP65. In steps SP64 and SP65, a process of changing the period of displaying an after-view in accordance with the value of the finger capture flag is performed. The changing process is performed under control of the overall controller 50.

Concretely, in step SP65, it is determined that “unintentional finger image capture” does not occur and display of a captured image on the LCD 7 is started for a period TM1 of displaying a normal after-view. In step SP64, it is determined that “unintentional finger image capture” occurs and display of the captured image on the LCD 7 starts for a predetermined period TM2 (>TM1). The period TM1 is a period which is preliminarily determined as a period of displaying a normal after-view, and the period TM2 is a period which is preliminarily determined as a period longer than the period TM1 of displaying a normal after-view. For example, the period TM1 can be set to about 5 seconds and the period TM2 can be set to about 10 seconds.

The user visually recognizes a captured image displayed on the LCD 7 for a predetermined period (TM1 or TM2) since the start of the after-view display and determines whether the captured image is stored as it is or erased (discarded). When the user recognizes occurrence of “unintentional finger image capture”, the user can give an erasure instruction by using the operation part 60 to the digital camera 1.

In step SP66, a branching process according to the presence/absence of the erasure instruction in the period TM1 or TM2 is performed. In the case where there is no erasure instruction in the period, the program advances to step SP68 where the captured image data is transferred from the image memory 55 to the memory card 59 and stored, and the image capturing process is finished. On the other hand, in the case where the erasure instruction is given in the period, the program advances to step SP67 where the image data captured in step SP61 is erased from the image memory 55 and is not stored into the memory card 59.

When the period of displaying an after-view is short, it can happen that the after-view display is finished before the user determines whether the image is to be stored or erased. Although an image recorded on the memory card 59 can be erased even after completion of the after-view display, it is more excellent from the view point of operability to erase the image during the after-view display. Under such circumstances, in the embodiment, the period TM2 of displaying an after-view in the case where the digital camera 1 detects occurrence of “unintentional finger image capture” is longer than the period TM1 of the case where the occurrence is not detected. Consequently, an advantage such that it is easy for the user to perform the erasing operation at the time of an after-view. In other words, longer time can be assured for determination of erasure of an image, so that an image accompanying unintentional finger image capture can be erased more reliably. Therefore, an image accompanying “unintentional finger image capture” can be prevented from being recorded as a captured image more reliably. In other words, capture of an image accompanying “unintentional finger image capture” can be prevented more reliably.

In the fourth embodiment, a message such as “finger obstruction” may be superimposed on an after-view image displayed.

E. Others

Although the embodiments of the present invention have been described above, the present invention is not limited to the above.

For example, in the first embodiment, whether a finger of the user is in an image or not is determined on the basis of presence or absence of a not-shifted low-brightness area. However, the present invention is not limited to the embodiment. For example, by comparing two or more images to detect a motion vector of a subject, the presence of a shifted area and a not-shifted area may be detected.

In the second embodiment, the case of performing the auto-focus control at a timing when the shutter release button is lightly pressed has been described. However, the timing of performing the auto-focus control is not limited to the timing. For example, the auto-focus control may be always performed when a live view image is displayed. Together with the auto-focus control operation, the operation of determining the “intentional finger image capture” may be also performed. In the case of always performing the auto-focus control when the live view image is displayed, it is preferable to move the lens from a present lens position to the near side end for the reason that the auto-focus control operation and the “unintentional finger image capture” determining operation can be performed more promptly as compared with the case of moving the lens through the entire lens driving range.

Although the case of applying the release lock operation (third embodiment) or the operation of setting time of displaying an after-view (fourth embodiment) as a modification of the operation performed after the determination in the first embodiment has been described, the present invention is not limited to the case. For example, as the operation performed after the determination in the second embodiment, the release lock operation in the third embodiment may be used. More concretely, after step SP30 (FIG. 23), operations in step SP51 and subsequent steps (FIG. 25) may be performed. Alternately, as the operation performed after determination in the second embodiment, the operation of setting time of displaying an after-view in the fourth embodiment may be used. More concretely, after step SP30 (FIG. 23), the operations in step SP61 and subsequent steps (FIG. 25) may be performed.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image generator for capturing a subject and generating image data;
a discriminator for discriminating whether a part of a user is included in an objective area to be captured or not on the basis of a plurality of pieces of image data generated in a time series manner by said image generator; and
a controller for controlling operation of said image capturing apparatus on the basis of a result of discrimination of said discriminator.

2. The image capturing apparatus according to claim 1, wherein the part of said user is a finger of said user.

3. The image capturing apparatus according to claim 1, further comprising:
a display for displaying said plurality of pieces of image data as preview display before photographing, wherein
said discriminator discriminates whether the part of said user is included in said objective area or not on the basis of said plurality of pieces of image data to be displayed on said display.

4. The image capturing apparatus according to claim 1, further comprising:
an indicator for notifying said user, wherein
said controller notifies said user of the result of discrimination by using said indicator when said discriminator discriminates that the part of said user is included in said objective area.

5. The image capturing apparatus according to claim 1, further comprising:
an image processor for generating image data to be recorded from image data generated by said image generator, wherein
said controller controls said image processor so as to generate said image-data-to-be-recorded obtained by eliminating an area including the part of said user from said image data generated by said image generator when said discriminator discriminates that the part of said user is included in said objective area.

6. The image capturing apparatus according to claim 1, wherein
said discriminator discriminates whether the part of said user is included in said objective area or not on the basis of a change in the position of a low brightness area in said plurality of pieces of image data.

7. The image capturing apparatus according to claim 6, further comprising:
a detector for detecting hue information of said low brightness area, wherein
said discriminator discriminates whether the part of said user is included in said objective area or not on the basis of a change in the position of the low brightness area in said plurality of pieces of image data and hue information detected by said detector.

8. The image capturing apparatus according to claim 7, wherein
said hue information is information of flesh color.

9. The image capturing apparatus according to claim 1, further comprising:
a focusing lens, wherein
said plurality of pieces of image data is image data generated in a time-series manner while moving the position of said focusing lens.

10. The image capturing apparatus according to claim 9, wherein
said discriminator discriminates whether or not the part of said user is included in said objective area on the basis of a change in contrast in a predetermined area in said plurality of pieces of image data.

11. The image capturing apparatus according to claim 10, wherein
said predetermined area is an area positioned in a peripheral portion of said objective area.

12. The image capturing apparatus according to claim 10, further comprising:
a detector for detecting hue information of said predetermined area, wherein
said discriminator discriminates whether the part of said user is included in said objective area or not on the basis of said change in contrast and said hue information detected by the detector.

13. The image capturing apparatus according to claim 12, wherein
said hue information is information of flesh color.

14. The image capturing apparatus according to claim 1, wherein
said controller inhibits image capturing operation of image-data-to-be-recorded when said discriminator discriminates that the part of said user is included in said objective area.

15. The image capturing apparatus according to claim 1, further comprising:
a display for displaying captured image data, wherein
said controller displays said captured image data on said display for a first period when said discriminator discriminates that the part of said user is not included in said objective area, and said controller displays said captured image data on said display for a second period which is longer than the first period when said discriminator discriminates that the part of said user is included in said objective area.

16. A method of controlling operation of an image capturing apparatus, comprising the steps of:
capturing a subject and generating image data in a time series manner;
discriminating whether a part of a user is included in an objective area to be captured or not on the basis of a plurality of pieces of image data generated in a time-series manner; and
controlling operation of said image capturing apparatus on the basis of a result of said discrimination.

17. The method according to claim 16, wherein
the part of said user is a finger of said user.
